(19) United States
(12) Patent Application Publication
(10) Pub. No.: US 2008/0114672 A1
(43) Pub. Date: May 15, 2008

(54) METHOD AND SYSTEM FOR BIDDING ON ADVERTISEMENTS

(76) Inventors: Sihem Amer Yahia, New York, NY (US); Raghu Ramakrishnan, Los Altos, CA (US); Michael Schwarz, Berkeley, CA (US); Jayavel Shanmugasundaram, Santa Clara, CA (US); Andrew Tomkins, San Jose, CA (US)

Correspondence Address: BRINKS HOFER GILSON & LIONE / YAHOO! OVERTURE, P.O. BOX 10395, CHICAGO, IL, 60610, US

(21) Appl. No.: 11/734,294

(22) Filed: Apr. 12, 2007

Related U.S. Application Data
(63) Continuation-in-part of application No. 11/595,585, filed on Nov. 9, 2006.

(51) Int. Cl. G06Q 40/00

(52) U.S. Cl. 705/37

(57) ABSTRACT

A system and method for bidding on advertisements. The system includes a query engine and an advertisement engine. The query engine receives a query from the user. The query engine analyzes the query to determine a query intent that is matched to a predetermined domain. A translated query is generated including the domain type. Once a domain is selected, the query may be further analyzed to determine generic domain information. The domain and associated information may then be matched to a list of advertisements. The advertisement may be assigned a score based on a bid price and a quality of the advertisement.

### CROSS REFERENCE TO RELATED APPLICATIONS

This application is a continuation-in-part of U.S. patent application Ser. No. 11/595,585, filed Nov. 9, 2006 and claims the benefit therefrom.

### BACKGROUND

1. Field of the Invention

The present invention generally relates to a system and method for bidding on advertisements.

2. Description of Related Art

Online search engines are often used to search the internet for specific content that is of interest to the user. This is generally accomplished by entering keywords into a search field that relate to the specific interest of the user. For example, if the user was interested in finding a recipe for apple pie, the user may enter the keywords “recipe”, “apple” and “pie” into the search field. Generally, the search engine would then try to match the entered keywords to web pages that contain the keywords or have been associated with the keywords through some methodology. The user is then provided with a list of search results that are ranked in order with the most relevant search results at the top of the list and the least relevant search results at the bottom of the list. Generally, revenue for the search engines would be generated by advertisements that are placed on the page along with the search results. The user could select the advertisement and be redirected to a web page for the ad sponsor. However, the advertisement may not have been optimally selected based on the user's immediate interest. Therefore, the user may be viewing advertisements for which they have no interest.

In view of the above, it is apparent that there exists a need for an improved system and method for bidding on advertisements.

### SUMMARY

In satisfying the above need, as well as overcoming the drawbacks and other limitations of the related art, the present invention provides a system and method for bidding on advertisements.

The system includes a query engine and an advertisement engine. The query engine receives a query from the user which is provided to a text search engine to perform a web page search. The query engine further analyzes the query to determine a query intent that is matched to a predetermined domain. A translated query is generated including the domain type. Various domains may be provided modeling typical user interaction such as searching for a hotel, looking for a plane flight, or shopping for a product. Once a domain is selected, the query may be further analyzed to determine generic domain information such as quantity and price, or domain specific information such as check-in date and check-out date for a hotel stay.

The domain and associated information may then be matched to a list of predefined advertisements. The advertisements may include bids, for example offers to advertise for certain domain, keywords, or combinations thereof for a predefined bid price. The advertisement is then assigned a score, for example, based on a bid price, as well as, a quality of the advertisement. As such, the advertisements may be provided in a list, where the list is ranked according to the score. The advertisers may bid on a spot in the list (the higher the bid, the higher the spot). Or the advertiser may bid on an advertisement channel, including all of the spots in the list, the area where the list is located, or all of the advertisement areas on the web page.

Further, a refined search interface may be provided including fielded selections based on the domain type. The fielded selections may be automatically determined based on the query information allowing the user to quickly refine his search criteria in a manner that is efficiently and accurately interpreted by the query engine to provide optimal advertisement results.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for bidding on advertisements;

FIG. 2 is an image of a web page for entering a query;

FIG. 3 is a graphical representation of a translated query;

FIG. 4 is another graphical illustration of a translated query;

FIG. 5 is a schematic view of the advertisement engine;

FIG. 6 is a flowchart illustrating a method of selecting advertisements based on bid information;

FIG. 7 is a graphical illustration of matching a translated query to an advertisement;

FIG. 8 is an image of a display including advertisement results and a refined search interface; and

FIG. 9 is an image of a display including advertisement results for a channel advertisement.

### DETAILED DESCRIPTION

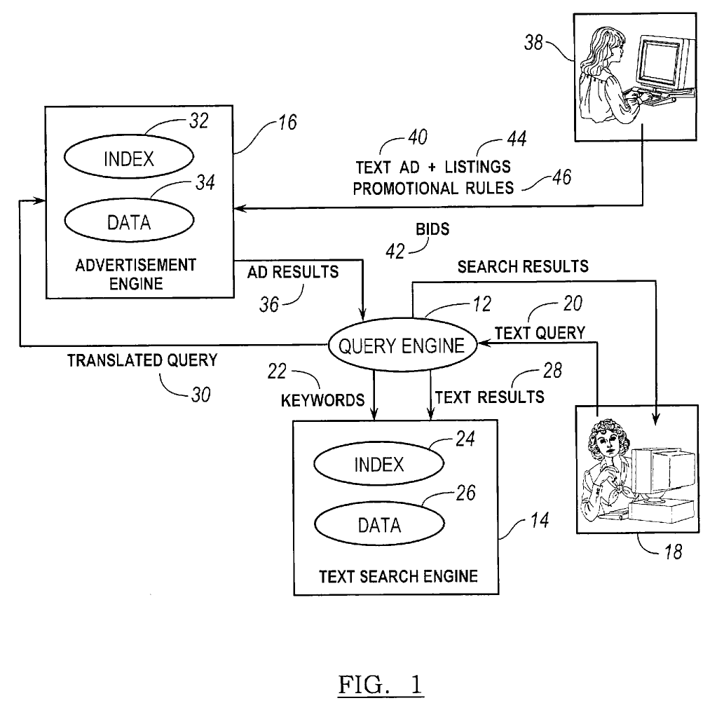

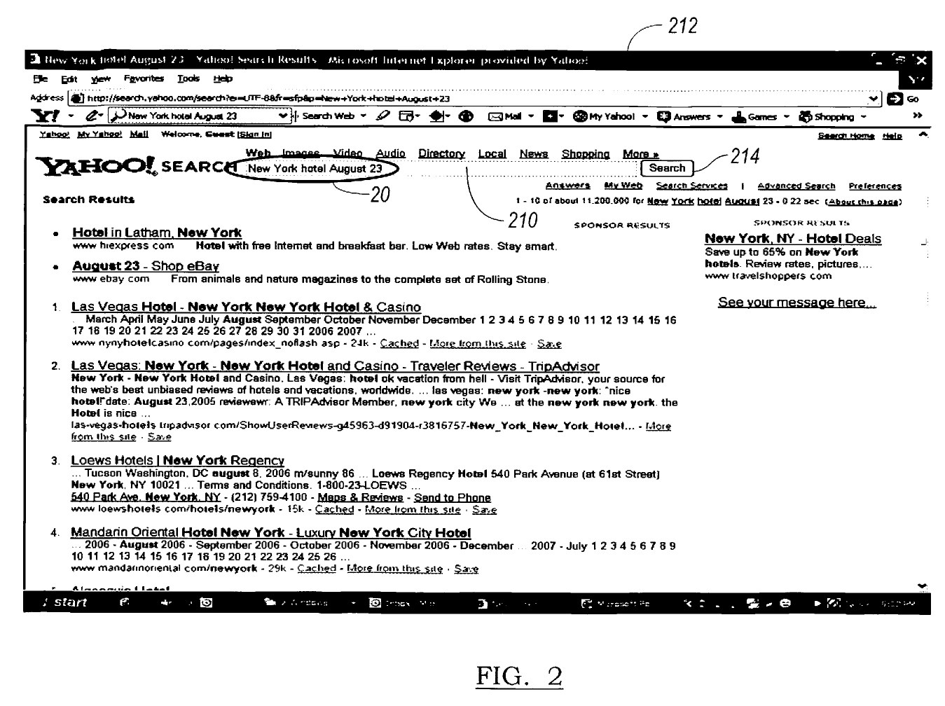

Referring now to FIG. 1, a system embodying the principles of the present invention is illustrated therein and designated at 10. The system 10 includes a query engine 12, and an advertisement engine 16. The query engine 12 is in communication with a user system 18 over a network connection, for example over an Internet connection. The query engine 12 is configured to receive a text query 20 to initiate a web page search. The text query 20 may be a simple text string including one or multiple keywords that identify the subject matter for which the user wishes to search. For example, the text query 20 may be entered into a text box 210 located at the top of the web page 212, as shown in FIG. 2. In the example shown, five keywords “New York hotel August 23” have been entered into the text box 210 and together form the text query 20. In addition, a search button 214 may be provided. Upon selection of the search button 214, the text query 20 may be sent from the user system 18 to the query engine 12. The text query 20 also referred to as a raw user query, may be simply a list of terms known as keywords.

Referring again to FIG. 1, the query engine 12 provides the text query 20, to the text search engine 14 as denoted by line 22. The text search engine 14 includes an index module 24 and the data module 26. The text search engine 14 compares the keywords 22 to information in the index module 24 to determine the correlation of each index entry relative to the keywords 22 provided from the query engine 12. The text search engine 14 then generates text search results by ordering the index entries into a list from the highest score entries to the lowest score entries. The text search engine 14 may then access data entries from the data module 26 that correspond to each index entry in the list. Accordingly,the text search engine 14 may generate text search results 28 by merging the corresponding data entries with a list of index entries. The text search results 28 are then provided to the query engine 12 to be formatted and displayed to the user.

The query engine 12 is also in communication with the advertisement engine 16 allowing the query engine 12 to tightly integrate advertisements with the user query and search results. To more effectively select appropriate advertisements that match the user's interest and query intent, the query engine 12 is configured to further analyze the text query 20 and generate a more sophisticated translated query 30. The query intent may be better categorized by defining a number of domains that model typical search scenarios. Typical scenarios may include looking for a hotel room, searching for a plane flight, shopping for a product, or similar scenarios.

One earlier example included the text query “New York hotel August 23”. For this example, the query engine 12 may analyze the text query 20 to determine if any of the keywords in the text query 20 match one or more words that are associated with a particular domain. The words that are associated with a particular domain may be referred to as trigger words. Various algorithms may be used to identify the best domain match for a particular set of keywords. For example, certain trigger words may be weighted higher than other trigger words. In addition, if multiple trigger words for a particular domain are included in a text query additional weighting may be given to that domain.

Once a domain has been selected, the keywords may be analyzed to identify known predicates for a particular domain. Predicates are descriptive terms that further identify the product or service being sought by the user. Some predicates are general predicates that may apply to all domains, for example the quantity or price of the product or service. Other predicates are domain specific predicates and fall into specific predefined categories for a particular domain. Referring to the “New York hotel August 23” text query example, once the domain is identified as the hotel domain, certain categories may be predefined that further identify the hotel stay sought, including for example the city, date, cost, etc. Accordingly, one possible format for the translated query may be provided below:

```
A translated user query may be a 4-tuple (kw, domain, gen_pred,
dom_pred)
    kw is a list of keywords (from the raw user query)
    domain is the user intent
    gen_pred and dom_pred are propositional logic formulas.
        gen_pred := ε | gen_pred ( [symbol] gen_pred) * |
            duration throughout time-range |
            quantity = value:float |
            price-range IN [ value:float , value:float ]
        dom-pred := ε | dom_pred ( [symbol] dom_pred) * |
        name:string = value:typedValue |
        name:string IN [ value:typedValue , value:typedValue ]
        name:string IN geographic-area
```

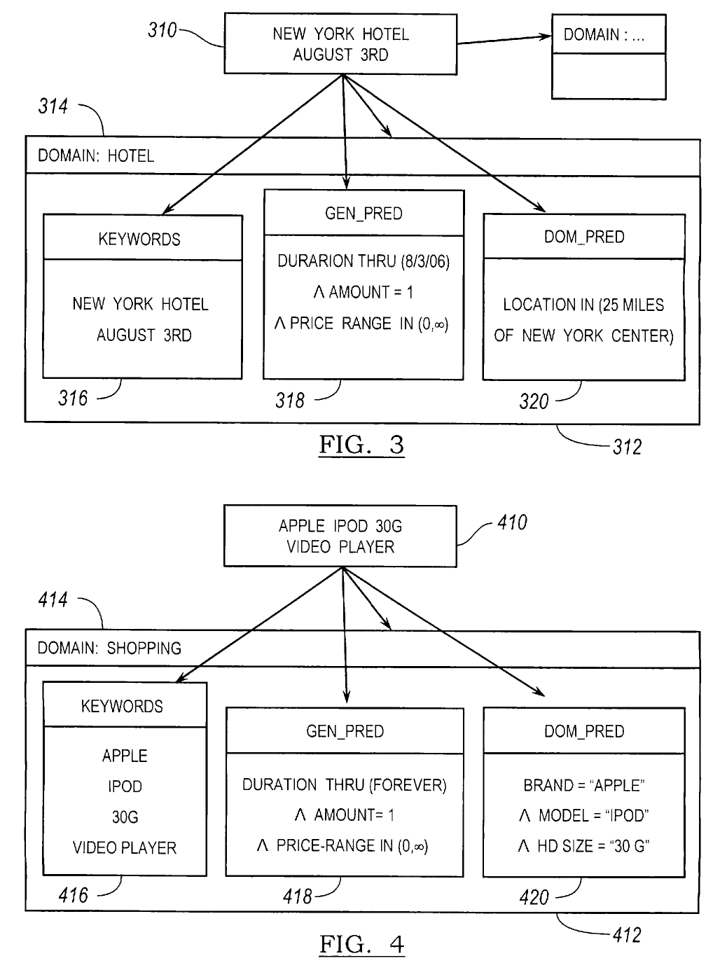

This concept is further illustrated graphically in FIG. 3. Block 310 represents the text query “New York Hotel August 3”. The translated query is denoted by block 312. The domain is denoted by block 314 and is identified as the hotel domain. The keywords “New York”, “Hotel”, and “August 3” are also included in the translated query as noted by block 316. General predicates 318 may be identified from the text query or keywords including the date of stay “Aug. 3, 2006”, the quantity (which may default to 1 for the hotel domain, could be identified by a phrase such as “2 rooms”), and the price range. Further, once the domain is identified as the hotel domain, domain specific predicates 320 can be further formatted for example the city and location (which may default to a value such as within 25 miles of the city center).

Another example, relating to shopping for a product, is provided graphically in FIG. 4. In this example, block 410 represents the text query “Apple iPod 30G video player”. The translated query is generally denoted by block 412. The domain 414 is identified as the shopping domain. Also included in the translated query 414 are the keywords 416 including “Apple”, “iPod”, “30G”, and “video player”. In this example, the general predicates 418 may include the date offered, the quantity, and the price range, each of which may be derived from the keywords. Since the domain 414 is identified as the shopping domain, the domain specific predicates 420 can be selected based on the shopping domain. The domain specific predicates 420 for the shopping domain may differ significantly from the hotel domain, for example the brand and model of the product. In addition, other predicates may be further specified, for example, based on a hierarchy of domain predicates. Accordingly, once the model predicate is identified as “iPod”, the hard drive size predicate can be identified and the keywords may be further analyzed to better specify the product sought.

Referring again to FIG. 1, the translated query 30 is provided to the advertisement engine 16. The advertisement engine 16 includes an index module 32 and a data module 34. The advertisement engine 16 performs an ad matching algorithm to identify advertisements that match the user's interest and the query intent. The advertisement engine 16 compares the translated query 30 to information in the index module 32 to determine the correlation of each index entry relative to the translated query 30 provided from the query engine 12. The scoring of the index entries may be based on an ad matching algorithm that may consider the domain, keywords, and predicates of the translated query, as well as the bids and listings of the advertisement. The bids are requests from an advertiser to place an advertisement. These requests may typically be related domains, keywords, or a combination of domains and keywords. Each bid may have an associated bid price for each selected domain, keyword, or combination relating to the price the advertiser will pay to have the advertisement displayed. Listings provide additional specific information about the products or services being offered by the advertiser. The listing information may be compared with the predicate information in the translated query to match the advertisement with the query. An advertiser system 38 allows advertisers to edit ad text 40, bids 42, listings 44, and rules 46. The ad text 40 may include fields that incorporate, domain, general predicate, domain specific predicate, bid, listing or promotional rule information into the ad text.

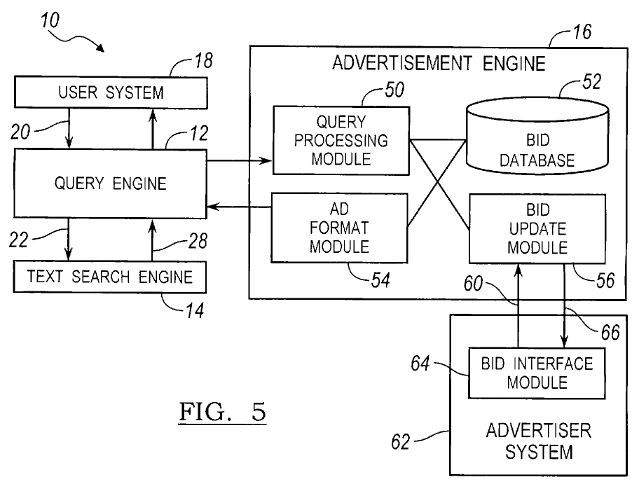

Referring to FIG. 5, the advertisement query 30 is provided to the advertisement engine 16. The advertisement engine 16 includes a query processing module 50, a bid database 52, an ad format module 54, and a bid update module 56. The advertisement query 30 is received by the query processing module 50. The query processing module 50 accesses the bid database 52 to retrieve bid information associated with the advertisement query 30. The query processing module 50 determines the ad placement based on the bid information that relates each advertisement to the advertisement query 30. For example, the ads may be arranged in a list from the highest bid at the top of the list to the lowest bid at the bottom of the list. The query processing module 50 charges an advertiser account associated with each advertisement an award amount based on the auction format, the bid placed, and the ad placement. Various auction models may be implemented by the query processing module 50. For example, an English auction, a generalized second price auction (GSP), a Vickrey-Clarke-Groves auction (VCG), or any other type of auction.

The ad format module 54 may receive the ad placement information from the query processing module 50 and format a list of ads including integrating ad information from the bid database 52 or other databases. For example, metadata tags may be used to integrate ad information into the ad content based on the advertisement query 30, the date, or other information. Accordingly, the advertiser may provide targeted offers to users based on such information. The advertisement results 48 including the formatted advertisement list and customized ad content are provided back to the query engine 12. The query engine 12 may format the advertisement results 36 and the search results 28 to be displayed to the user by the user system 18.

The bid update module 56 is in communication with the bid database 52 to update advertiser bid information, automatically or otherwise. In one example, the bid update module 56 automatically calculates and updates the suggested bid at a fixed time interval. The advertiser may automatically accept the suggested bid, manually accept the suggested bid, or enter its own bid.

To further describe calculation of advertisement scoring, the following definitions are provided:

Q(N,I) is a vector that we will refer to as quality vector. It includes as its components attributes of advertiser N and of his ad for auction I such as clickability (denoted by y, as well as a proxy for ad quality, proxies for user experience from the ad etc.)

B(N,I) is the bid of an advertiser N for auction I and B is a vector of all bids for all advertisers.

Let S(B(N,I),Q(N,I)) denotes a function that maps an advertiser's bid and his quality into his score. (examples include a simple scoring function where score equals to the bid, a scoring function where score is a product of bid and some of the attributes of the ad such as clickability or a product of bid clickability and overall quality of the ad)

C(N,I,J) is the lowest amount that advertiser N may bid to attain position J in auction I. For instance if all ads have the same attributes such as quality then, C(N,I,J) equals to the bid of J-th highest bidder (excluding the instant advertiser) plus one cent (or a minimum bid increment).

The GSP auctions are a class of auctions that are an industry standard for selling internet advertisements. In such auctions ads are arranged in order of scores (with the more desirable positions allocated to ads with higher scores). In a GSP auction the payment of each bidder is computed as the smallest amount that the bidder has to bid to maintain his position. More formally, the score of bidder in position J is denoted by S(J). Then in a GSP auction the bidder N who occupies position J will pay amount C(N,I,J) that solves the following equation

S(C(N,I,J),Q(N,I))=S(J+1) (1)

### Note that if the scoring function is equal to the bid then the per click payment of advertiser in position J equals to the bid of advertiser in position J+1 (plus one cent if the bid increment is one cent).

To enhance the ability of the advertiser to determine its bid amount, the bid update module 56 is in communication with a bid interface module 64 which may be located on the advertiser system 62. Accordingly, the bid interface module 64 allows the advertiser to enter the value that the advertiser places on each click from a key word. The bid interface module 64 may display the suggested bid and may allow the user to override the suggested bid. The bid interface module 64 may also allow the user to select an update time interval or, alternatively, select updating based on the advertisement query or the changing of a competitor's bid.

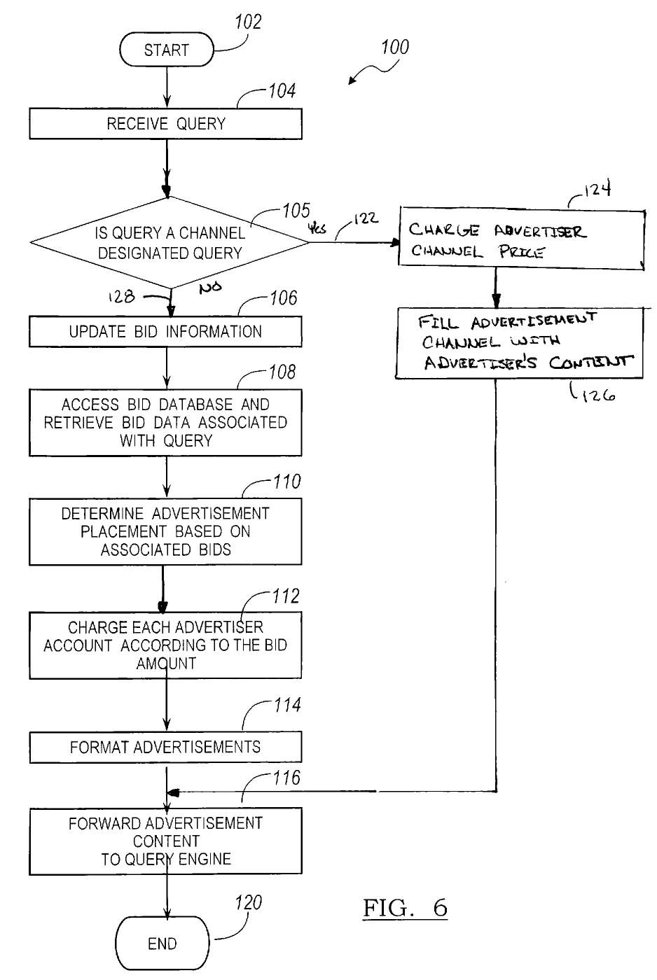

Now referring to FIG. 6, a method 100 for generating advertisements is provided. The method 100 starts in block 102. An advertisement query is received as noted in block 104. In block 105, the advertisement engine determines if the query is a channel designated query. The advertisement engine may designate a query to a channel based on a predefined percentage of queries that match specified criteria. For example, twenty percent of hotel domain queries may be allocated as channel queries. If the query is designated to a channel advertisement, the method 100 follows line 122 to block 124. In block 124, the channel advertiser is charged the channel price. The channel price may be a predefined cost per channel advertisement. This would implement pricing on a per impression basis. Alternatively, the channel price may be determined based on a separate bidding scheme related to the channel advertisements. In addition, other embodiments may be devised where the channel is compared to a group of bids, for example bids on a list, as described later. In block 126, the advertisement channel, such as a list of advertisements, may be filled the advertiser's content. The method 100 then proceeds to block 116, where the advertisement content is provided to the query engine.

Referring again to block 105, if the query is not a channel designated query, the method 100 follows line 128 to block 106. In block 106, a bid update module 56 may be notified to update bids on keywords corresponding to the advertisement query 30. The bid database 52 is then accessed and the bid data is associated with the advertisement query 30 is retrieved, as noted in block 108. In block 110, the advertisement placement is determined for each advertisement based on the bid order. For example, the highest bid is placed at the top of the advertisement list, while the lowest bid is placed at the bottom of the advertisement list. In block 112, each advertiser account is charged according to the bids placed and the auction rules. For example, in a GSP auction the top bidder will pay an amount equal to a second-place bid, the second-place bidder will pay an amount equal to the third-place bid, and so on. Accordingly, the advertisement price is determined on a per click basis. The advertisements are formatted and the appropriate advertisement content is generated, as noted in block 114. As previously noted, advertisement content may be modified based on the advertisement query 30, the date, advertiser special offers, or other rules specified by the advertiser. In block 116, the advertisement content is forwarded to the query engine 12 for display to the user. The method ends in block 120.

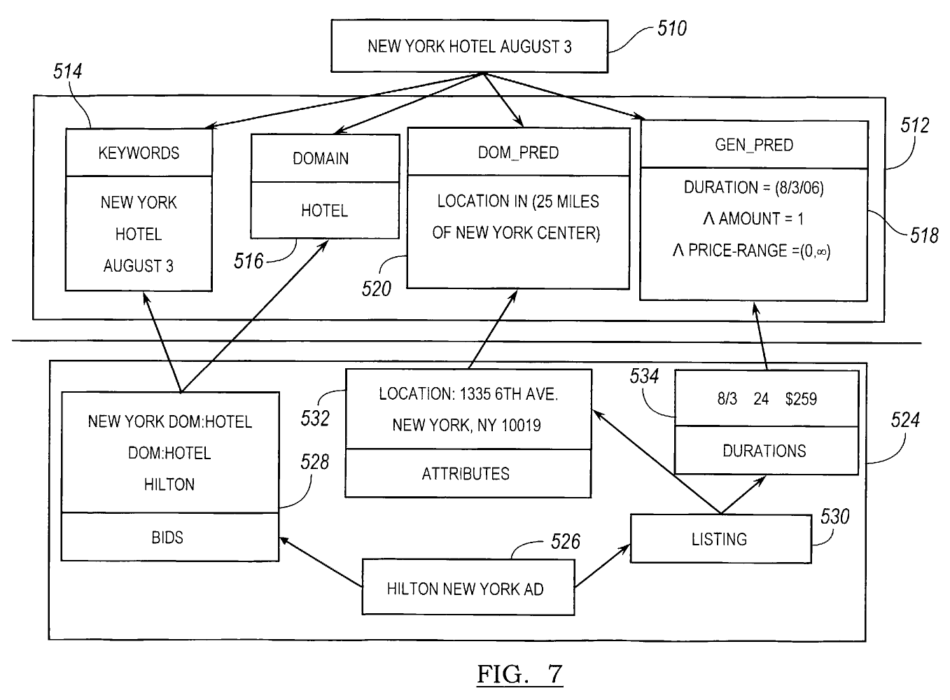

Referring to FIG. 7, an ad matching scenario is illustrated graphically. Block 510 represents the raw text query “New York Hotel August 3” and, as previously discussed, is used to generate the translated query 512. The advertisement 524 acts as a counterpart to translated query 512. In one example of the system, the advertisement 512 is defined as:

```
a 5-tuple (title, desc, Url, bids, listings)
  title: string
  desc: string description of the product, service, or offer
  url: URL which points to the webpage of the ad
  bids: { domain terms* | term+ } the bidded terms and domain
  listings: { listing }
```

Further, the listing may be:

```
a pair (attributes, duration)
  attributes: { (name:string, value:typedValue) } which describes features
  of the ad listing
  duration: { (time:duration, amount:float, price:float ) } which describe
  the price and availability of the ad listing for a time duration
```

### Accordingly, the advertisement 524 in FIG. 7, graphically illustrates a title 526, bids 528, and listings 530.

The translated query 512 is matched to the advertisement 524 to determine an ad match score indicative of the correlation between the product or service being offered and the query intent. The bids 528 form part of the advertisement 524 and may be matched to the keywords and domain of the translated query 512. The keywords 516 include the terms “New York”, “Hotel”, and “August 3”. Similarly, the bids 528 includes a bid on the combination of the Domain “Hotel” and the keyword “New York”, accordingly these bids are compared to the keywords 514 and domain 516 of the translated query 512. Since there is a match to both the domain and keyword the ad match score is higher than if just the domain Hotel had matched. Generally, the more specific the bid, the higher the bid price will be because the more relevant the advertisement will be to the query intent and the more likely the user will purchase the advertised product or service. The bid price may also be included in calculating the ad match score and or used to order the ads within a list that is displayed with the search results.

Although, it is clear to one of ordinary skill in the art that other bidding models may also be applied. Including bidding models that match bids to general or domain specific predicates.

The architecture described also incorporates the ability to bid on a combination of domain, fields and terms. As described above, the domain may identify a predefined query intent, such as a search for a hotel, insurance, or a laptop. Further, fields may be predefined to more specifically identify the desired product or service. The fields may correspond to the general and domain specific predicates. The framework enables advertisers to bid on a domain, although, advertisers can also bid on specific fields in a domain (e.g., brand name, screen size). Advertisers may also bid on specific terms (as in current sponsored search) that are not associated with a predefined domain or field. Further, advertisers can bid on any combination of domain, fields and terms (e.g., domain=insurance, terms=home, Geico) (e.g., field=brand, terms=IBM, Dell). This bidding framework is applicable to both sponsored search and banner ads. Typically, the more specific the bid parameters the higher price of the bid. This is because the bid will reach a more targeted audience. The framework captures a family of bidding models which benefit from domain information. These models range from the simple channel model to bidding on individual terms (current sponsored search).

The architecture described also provides the ability to combine the various pricing models with the bidding described above. For, example the order in which advertisements are displayed may depend on the bid, but may also be influenced by a quality score. The quality score may consider one or many of the following factors: advertiser volume, searcher preference, clickability, relevance, and price. The quality score may simply be a weighted average of one or many of the above factors. Further, the price used to determine quality of the advertisement may include a discounted price based on pricing rules, bonus rules, or a shopper specific discount. For example, the system may include the ability to combine pricing such as rate cards (from Y! Shopping) with the bidding described above.

Further, the user may bid on a channel of advertisements. As such, the advertiser may bid for all advertisements on a page. Alternatively, the advertiser may bid for all the advertisements on a page belonging to a domain. This could be implemented for a hotel query, such that the advertiser bids on the hotel domain and places hotel adds in the advertisement list and possibly in the banner ad. Meanwhile, advertisements belonging to complimentary domains (i.e. flights, travel tours, etc) may be placed in the rest of the list. Further, various ad allocation (i.e., selection of ads to show to users) and channel bidding can be combined with the bidding described above.

To illustrate the above mentioned techniques the bid examples in Table 1 are provided below.

TABLE 1

| | | Dell Laptop Black | | | | | |
|---|---|---|---|---|---|---|---|
| | | 30 GB Multimedia | | | Apple Laptop Black | | |
| | | Speakers | | | Multimedia Speakers | | |
| | Query | Bid | | | Bid | | |
| # | Bid | Price | Quality | Total | Price | Quality | Total |
| 1 | Domain: Laptop | 0.30 | 0.80 | 0.24 | — | — | — |
| | Field: HD: 30 GB | | | | | | |
| | Field: Color: Black | | | | | | |
| 2 | Domain: Laptop | 0.20 | 0.5 | 0.10 | 0.20 | 0.5 | 0.10 |
| | Field: Color: Black | | | | | | |
| 3 | Domain: Laptop | 0.12 | 0.5 | 0.06 | 0.12 | 0.5 | 0.06 |
| | Field: Color: Black | | | | | | |
| 4 | Term: Multimedia | 0.05 | 0.2 | 0.01 | 0.05 | 0.2 | 0.01 |
| 5 | Domain: Laptop | 0.08 | 0.2 | 0.016 | 0.08 | 0.2 | 0.016 |
| 6 | Term: Apple | — | — | — | 0.5 | 0.1 | 0.05 |
| | Term: Speakers | | | | | | |
| 7 | Domain: Laptop | 0.50 | 0.5 | 0.25 | 0.50 | 0.5 | 0.25 |
| | Term: Multimedia | | | | | | |
| | *Channel | | | | | | |

Two query scenarios are provided with regard to the bids provided in Table 1 above. The first query scenario is for a text query “Dell Laptop Black 30 GB Multimedia Speakers” and the second query scenario is for the text “Apple Laptop Black Multimedia Speakers”. During query processing, certain of the text items may be analyzed to identify the domain, for example Domain: Laptop. Further, other text may further correspond to predefined fields that further identify the type of laptop. For example, “30 GB” may be identified and related to the hard drive field while “Black” may be related to the color field.

As such, the advertisers may enter bids on domains, fields, terms, or any combination of the above. Accordingly, the first bid is on queries that are identified to the laptop domain and include a value of 30 GB in the hard drive field and include the value black in the color field. Since the second query does not include the 30 GB value for the hard drive field, the first bid is not matched with the second query. The second bid is related to the domain laptop and the value black for the color field. As such, the second bid does not require the hard drive field to have the value of 30 GB. Therefore, the second bid is matched with both the first and second queries. For the example given in Table 1, we will assume that the top five bids will be shown in an advertisement list along with the search results. Further, bids on various combinations of domains, fields, and terms may be concurrently analyzed for a query. In addition, it can be seen that multiple advertisers may bid on the same combination of domains, fields, and/or terms, as denoted by bids two and three.

For the example given in Table 1, the bid price is multiplied by the quality score to provide a total score for the advertisement that denotes the order each bid will be displayed in the list. Accordingly for the first query, advertisements 1-5 will be displayed. The sixth advertisement will not be displayed and is not matched with the first query as the term “Apple” does not appear in the first query. Further, the last advertisement is denoted as being a bid on an advertisement channel.

A bid on an advertisement channel may relate to a bid on all of the advertisements in the advertisement list or all the advertisements on a web page. In addition, the channel bid may relate to all of the advertisements on a web page or in a list for a particular domain, thereby allowing the advertisement to be paired with complementary domains, such as domains of common interest to the use such as laptop peripherals or carrying cases, for the laptop domain, that are not in competition with the product or service corresponding to the identified domain.

According to one method, the advertisement channel may be provided at a set predetermined price and may be exercised a predetermined percentage of the queries assigned to a particular domain. Alternatively, advertisers may bid on an advertisement channel associated with a particular domain and the percentage of executions may correspond to the bidding position of the particular advertiser.

Another method of selecting a bid on an advertisement channel over multiple bids may include determining if the total score is greater than the sum of the scores for the top number of advertisements that would be in the list or in the web page. Therefore, for the example as described with reference to Table 1, the sum of the top five scores would be equal to 0.24+0.10+0.06+0.01+0.016=0.4026 which is greater than the total score for the channel advertisement bid of 0.25. However relative to query two, the channel bid of 0.25 is greater than the sum of the other top five advertisement bids, particularly advertisement bids 2-6. As such, the bid may be awarded to the channel bid.

In practice, many more bids will typically be evaluated for each combination, as well as, additional combinations of domains, fields, and terms. However, the above described scenario is one example of how such an algorithm may be implemented. Further, as described above, the quality score may be based on various weighted combinations of parameters, such as advertiser volume, searcher preference, clickability, relevance, and product in price, as well as, any combination of the above. Further, the total score may be calculated using a more complex algorithm than the simple multiplicative calculation provided, but may included multiplicative and additive terms including various polynomial modeling. In addition, other factors may also be considered in determining how to award a bid between multiple bids versus a channel, or one channel versus another channel.

To further describe the quality score, the predicates 518, 520 of the translated query 512 may be compared with the listings 530 of the advertisement 524. One or more listings 530 may be related to a particular domain type. Further, each listing 530 may be related to a particular product or service for sale by the advertiser. General predicates may be identified from the text query or keywords including the date of stay “Aug. 3, 2006”, the quantity, and the price range, as denoted by block 518. Similarly, the domain specific predicates 520, for example the city and location, can also be generated based on the keywords 514. Accordingly, the attributes 532 of each listing 530 of the advertisement 524, such as the address “1335 6^{th} Ave. New York, N.Y. 10019”. may be matched to the domain specific predicates 520 to improve the ad match score of the advertisement. In addition, the durations 534, such as the date, quantity available, and advertised price, may also be matched to the general predicates 518 of the translated query 512, to further define the ad match score.

In one example, the add matching algorithm may be defined as:

```
Given a user query Q= (kw, domain, gen_pred, dom_pred)
        Let gen_pred.amount return the number of items wanted
        Let gen_pred.duration return the time duration of the items
        Let gen_pred.price_range return the price range accepted by the user
Given a set of ads Ads= {(title, desc, url, bids, listings)} where listings = { (A, D) } and
A=Attributes and P=Durations
        Given d in D. let d.duration return an available time duration of the item
        Given d in D. let d.amount return the available amount of the item during
        the time p.duration
        Given d in D. let d.price return the price of the item during the time
        p.duration
    Where the following predicates are define
        satisfy_domain(l.A, Q.dom_pred) returns true iff the attributes of a listing /
        satisfies the domain predicates of Q
        satisfy_general(P, Q.gen_pred) returns true if all duration tuples (D) of a
        listing satisfy the general predicates of Q. Specifically,
            satisfy_general(D, gp) = ∀d ∈ D.(d.amount ≧ gp.amount [symbol]
            d.duration ∈ gp.duration [symbol] d.price ∈ gp.price_range [symbol]
            ∀c ∈ chronons(gp.duration).∃d′ ∈ D.(c ∈ d′.duration))
        satisfy(l, Q, D′) return true iff a listing / satisfies the domain predicate of Q
        and all duration tuples in D′ satisfy the general predicate of Q. Specifically,
            satisfy(l,Q,D′) = satisfy_domain(l.A,Q.dom_pred) [symbol]
            D′ ⊂ l.D.(satisfy_general(D′,Q.gen_pred))
    Given a query Q and a set of ads Ads, Match(Q, Ads) defines the set of matching
    ads of the query Q
Match(Q, Ads) = {(title,desc,url,listings) | ∃ad ∈ Ads.(title = ad.title [symbol]
desc = ad.desc [symbol] url = ad.url [symbol] ∃t ∈ ad.bids.(contains(Q.terms, t.terms) [symbol]
(t.domain = null [symbol] t.domain = Q.domain)) [symbol]
listings = {(l.A, D) | l ∈ ad.listings [symbol] satisfy(l,Q,D)} }
```

Further, rules may be defined by the advertiser and applied to the advertisement to provide the user special offers. The rules may be implemented based on information provided in the translated query. In one example, each rule is defined as:

a pair (condition, action)

where the condition is something to be fulfilled by the user and the action is an offer that the advertiser will provide in response to the condition being fulfilled.

The system may be configured such that the user system may directly initiate a purchase from the advertisement. Accordingly, the rule may be formatted into the advertisement and applied by the query engine 12. This may result in both the regular price and a discounted price being displayed based on analysis of the predicates. In one example, the rule may be a total price rule that affects the price of a multi quantity or multi item transaction. For example, the advertisement may incorporate a phrase such as “You will get 5% off if you stay for 2 nights or longer” and accordingly the query engine may apply the discount to the purchase. Similarly, the advertisement may incorporate a phrase such as “Get $20 off when your order is $100 or more” and the query may deduct the discount from the transaction if the condition is fulfilled. In one example, total-price rules (TP) take as inputs a user query Q, a set of listing attributes A and a total price of the order tprice, as further defined below:

TP-rule(Q,A,tprice) = (TP-cond, afunc)

| | |
|---|---|
| TP-cond | = TP-pred ( [symbol] TP-pred)* |
| TP-pred | = Q.domain=name:domain ( [symbol] attribute-pred )* \| |

```
        genAttrName = value:float |
        genAttrName IN [ value:float, value:float]
genAttrName= Q.quantity | total-price | Q.duration
attribute-pred= A.name:string = value:typedValue |
    A.name:string IN [ value:typedValue, value:typedValue]
    A.name:string IN geographic-area
afunc = genAttrName | A.name | constant:numeric |
        afunc * afunc | afunc + afunc | afunc \hat{ } afunc |
        afunc div afunc | afunc mod afunc
```

Another rule may be a bonus rule. Bonus rules may provide a secondary or unrelated benefit to the user when the condition is fulfilled. For example, the advertisement may incorporate a phrase such as “You will get free parking if you stay in our studio for 2 nights” or “You will receive free shipping on your order of $48.95 or more”. Accordingly, the query engine 12 may add the additional item to the order at no charge or included at the special price when the condition is fulfilled by the user. In one example, bonus rules take as inputs a user query Q, a set of listing attributes A and a total price of the order tprice, as defined below:

Bonus-rule(Q,A,tprice)=(TP-cond, bonus:String)

Yet another rule may include a duration rule. The duration rule may provide a discount based on a length of stay. For example, the advertisement may incorporate a phrase such as “You will get 10% off for weekday stays in our hotel”. Accordingly, the discount may be applied if the selected duration of the stay meets the duration rule defined by the advertiser. In one example, Duration rules (DR) take as inputs a user query Q, a set of attributes A, a time duration and a price of the listing in the time duration, as further defined below:

| DR-rule(Q,A,duration,price) = (DR-cond, afunc) | |
|---|---|
| DR-cond | = DR-pred ( [symbol] (DR-pred \| TP-pred))* |
| DR-pred | = duration IN time_range \| |
| | price IN [ value:float , value:float ] |
| time_range | = { value:duration (, value:duration)* } |

The system may apply certain assumptions to the application of the aforementioned rules. For example the system may apply a limit of one duration rule on each time duration. Similarly the system may be configured to apply a limit of one total-price rule on each order.

In yet another exemplary system, the match algorithm may be performed first to generate a list of applicable advertisements. Next the advertisement engine may apply the set of duration rules. Then the set of total-price rules may be applied to the list of advertisements. Finally the advertisement engine may choose the result with the minimum total price or rank the results from lowest to highest price. Accordingly, one implementation of the duration rules may be defined as provided below:

Based on Match(Q, Ads)
For each time duration of a listing, generate the set of all potential
promotional prices (PSet)
Match(Q,Ads,DR) = {(title,desc,url,listings) | ∃ad ∈ Match(Q, Ads).
title = ad.title [symbol] desc = ad.desc [symbol] url = ad.url [symbol] listings =
{(l.A, PSet) |
∃l ∈ ad.listings.(PSet = {P | ∃d ∈ 1.D.(P = {price | price = d.price [symbol]
∃dr ∈ DR.(dr[Q,l.A,d.time,d.price].condition [symbol]
price = dr[Q,l.A,d.time,d.price].action)})}}

### Further, for an implementation where the advertisement is matched with duration rules and total price rules the additional procedure may also be implemented.

Based on Match(Q, Ads, DR)
For each listing, output the lowest total price

Given a set of set P, rep(P) is a multi-set s.t.
$∀ r ∈ rep ( P ) . ∃ p ∈ P . ( r ∈ P ) ⋀ ∀ p ∈ P . ∃ r ∈ rep ( P ) . ( r ∈ P ) ⋀ \vert rep ( P ) \vert = \vert P \vert \\ Match ( Q , Ads , DR , TR ) = \{ ( title , desc , url , listings ) \vert ∃ ad ∈ Match ( Q , Ads , \\ DR ) . title = ad . title ⋀ desc = ad . desc ⋀ url = ad . url ⋀ listings = \{ ( l . A . tprice ) \vert \\ ∃ l ∈ ad . listings . ( TPS et = \{ {\sum }_{r ∈ R} r \vert R ∈ rep ( 1. PSet ) \} ⋀ DRSet = \{ p \vert \\ ∃ tprice ∈ TPSet . ( p = tprice ⋁ ∃ tp ∈ TP . ( tp ( Q , l . A , tprice ) . condition \\ ⋀ p = tp ( Q , l . A , tprice ) . action ) ) \} ⋀ tprice = MIN ( DRSet ) \} \}$

For the implementation described above, Match(Q,Ads) returns the (title, desc, url, listings) of each ad in the set of available Ads such that this ad satisfies the following conditions: some of the ad's bidded terms are contained in the query terms, the domain of those bidded terms is the same as the query domain, the listings are defined as all listings which satisfy satisfy(I,Q,D). Further, if no listing exists in the ad which satisfies satisfy(I,Q,D), no listing is returned for that ad. The process satisfy(I,Q,D) receives a listing I, a query Q and all duration tuples of I, and checks if the listing satisfies the domain predicates of Q (satisfy_domain(I.A, Q.dom_pred)) and the general predicates of Q (satisfy(D,gp)). Only the formula for the general predicates satisfaction is provided since the domain predicates satisfaction changes based on each domain. The process satisfy_general(D,gp) checks if all the durations in a listing I satisfy the amount, the duration and the price predicates.

The advertisement engine 16 may then generate advertisement search results 36 by ordering the index entries into a list from the highest correlating entries to the lowest correlating entries. The advertisement engine 16 may then access data entries from the data module 34 that correspond to each index entry in the list from the index module 32. Accordingly, the advertisement engine 16 may generate advertisement results 36 by merging the corresponding data entries with a list of index entries. The advertisement results 36 are then provided to the query engine 12. The advertisement results 36 may be incorporated with the text search results 28 and provided to the user system 18 for display to the user.

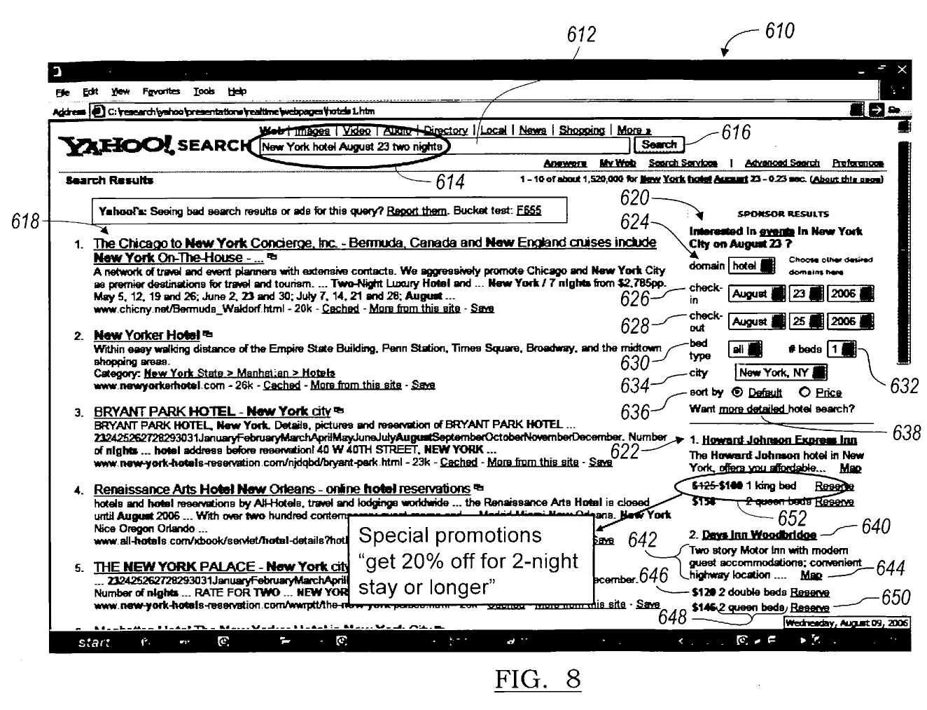

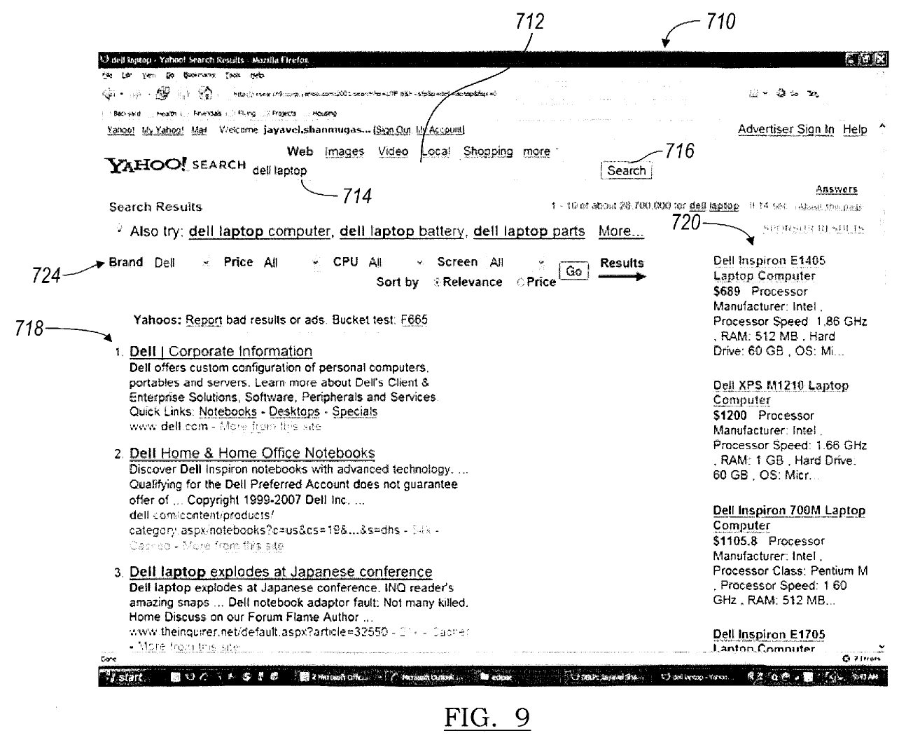

The query engine 12 may format the advertisement results 36 and the search results 28 to be displayed to the user by the user system 18. One example of a display generated by the query engine 12 is illustrated in FIG. 8. The display 610 may be a web page provided from the query engine 12 to the user system 18. To initiate additional searches, the display 610 includes a query input 612 containing the previous text query 614 and a search button 616, allowing the user to modify the previous search and initiate a new search. In addition, the display 610 includes a list of text search results 618 and a list of advertisement results 622.

The list of text search results 618 is provided in a ranked order based on the correlation item found with the text query 614 as described above. Similarly, the advertisement results 622 are provided in ranked order based on ad match score, also previously described. Further, a refined search interface 620 is provided to allow the user to more specifically identify products or services of interest. The refined search interface 620 may include field drop down selections, option selections, buttons, links, and other similar interface controls. The controls and their contents may be formatted and automatically filled based on a predefined model for the domain and the translated query information including the domain, the keywords, the predicates, or any combination thereof.

In the example shown, a domain control 624 is provided as a drop down selection including the hotel domain based on the previous example described. Further, the domain control 624 allows the user to quickly change the domain for the query and initiate a new search. This will efficiently allow the advertisement engine 16 to update the advertisement results 36 to match the query intent. A check-in date control 626 is provided including drop down selections for the month, day, and year. As can be seen from the entered text query, the check-in month and date can be defaulted to “August 23” based on the keywords provided, while the year can be defaulted to the current year according to default schemes for the particular domain. Similarly, a check-out date control 628 is also provided including the month, day, and year. Accordingly, the query engine 12 may derive the check-out date based on the check-in date and the keywords “two nights”. Accordingly, the query engine 12 may automatically set the check-out date control 628 to Aug. 25, 2006. In addition, the refined search interface 620 may include a bed type control 630 and a number of beds control 632 that may be set to default values based on the text information provided, although one of ordinary skill in the art could certainly understand that schemes could be provided to determine the bed type and number of beds from the keywords based on entries such as “two queens” or “two beds”. The city control 634 may also be defaulted to “New York, N.Y.” based on the keywords provided for the given translated query. Option buttons may also be provided to select between a limited number of criteria such as the sort control 636 allowing the user to sort by ad match score or price. In addition, a button or link may also be provided to initiate a new search based on the fielded entries of the refined search interface 620, as denoted by link 638. The refined search interface 620 with, predefined fielded keywords, allow the user to quickly switch between domains and identify specific features of the product or service that they are looking for while allowing the query engine 12 to efficiently and effectively match advertisements according to the user's interest.

The ad search results 622 are also formatted for ease of use. Based on the ad format, each advertisement may be provided with a title 640 including an underlying URL or link. Each ad includes a description 642 that may be integrated with specific ad or bid information based on the translated query, including the domain, keywords, or predicates. In addition, a map link 644 may be provided where appropriate. To allow the user to quickly and effectively obtain the product or service being advertised, multiple offers may be provided in the advertisement based on the listings and the predicates. Accordingly, a price 646 may be provided along with attribute information 648 such as the number of beds. Further, a control 650 such as a link or button may be provided to immediately reserve or purchase the product or service based on pre-obtained account information or by initiating a purchase process based on the selection. Further, rules may be applied to the listings based on the predicate information to identify and display special offers to the user. A discounted price 652 is provided to illustrate a rule that provides the user a discount based on the check-in and check-out date indicated by the user. Accordingly, the display 610 allows the user to quickly and effectively review search results, ad results, and refine search criteria using the refined search interface 620 to identify products and services of interest.

Similarly, a display generated for a channel advertisement is provided in FIG. 9. The display 710 may be a web page provided from the query engine 12 to the user system 18. To initiate additional searches, the display 710 includes a query input 712 containing the previous text query 714 and a search button 716, allowing the user to modify the previous search and initiate a new search. In addition, the display 710 includes a list of text search results 718 and a list of advertisement results 720. However, in the channel advertisement, the group of advertisements in the list of advertisement results 720 is associated with a single advertiser. In addition, controls 724 are provided to further define the advertisement criteria based on predefined fields that are associated with the given domain. After the controls. 724 are updated the advertisement results 720 are refined to provide more relevant advertisements to the user.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

1. A method for bidding on advertisements, the method comprising the steps of:
defining a plurality of domains that correspond to a plurality of possible user intents;
receiving bids from advertisers on a domain of the plurality of domains;
matching a query to the domain of the plurality of domains;
determining whether to display an advertisement based on the domain;
generating an advertisement for display to the user.

2. The method according to claim 1, wherein the bids relate to a combination of the domain and fields and the determination whether to display the advertisement is based on the domain and the fields.

3. The method according to claim 1, wherein the bids relate to a combination of the domain and terms and the determination whether to display the advertisement is based on the domain and the terms.

4. The method according to claim 1, wherein a bid of the bids relates to an advertisement channel.

5. The method according to claim 4, wherein the bid relates to all of the advertisements on a web page.

6. The method according to claim 5, wherein the bid relates to all of the advertisements on a web page that match the domain.

7. The method according to claim 4, wherein the bid relates to all of the advertisements in a list.

8. The method according to claim 7, wherein the bid relates to all of the advertisements in a list that match the domain.

9. The method according to claim 1, further comprising selecting a bid on an advertisement channel by comparing a first score of the bid on the advertisement channel with a second score of a list of advertisements.

10. The method according to claim 1, wherein the determination to display the advertisement is based on a bid price and a quality score.

11. The method according to claim 10, wherein the quality score is based on at least one of an advertiser volume, a searcher preference, a clickability score, a relevance score, and a product price.

12. The method according to claim 10, wherein the quality score is based on a weighted combination of an advertiser volume, a searcher preference, a clickability score, a relevance score, and a product price.

13. A system for generating advertisements for display to a user, the system comprising:
a query engine configured to receive a query from the user; and
an advertisement selection engine in communication with the query engine and configured to receive bids on a domain of the plurality of domains, the advertisement selection engine matching the query to the domain of the plurality of domains and determining whether to display an advertisement based on the domain.

14. The system according to claim 13, wherein the advertisement engine determines whether to display the advertisement based on a combination of the domain and a field.

15. The method according to claim 13, wherein the advertisement engine determines whether to display the advertisement based on a combination of the domain and a term.

16. The method according to claim 13, wherein the advertisement engine determines whether to exclude other advertisements that match the domain from a web page.

17. The method according to claim 13, wherein the advertisement engine determines whether to exclude other advertisements that match the domain from a list.

18. The method according to claim 13, wherein the advertisement engine determines whether to display the advertisement based on a bid price and a quality score.

19. In a computer readable storage medium having stored therein instructions executable by a programmed processor for updating bids for an advertisement, the storage medium comprising instructions for:
defining a plurality of domains that correspond to a plurality of possible user intents;
receiving bids from advertisers on a domain of the plurality of domains;
matching a query to the domain of the plurality of domains;
determining whether to display an advertisement based on the domain; generating an advertisement for display to the user.

20. The computer readable storage medium according to claim 19, wherein the bids relate to a combination of the domain and fields and the determination whether to display the advertisement is based on the domain and the fields.

21. The computer readable storage medium according to claim 19, wherein the bids relate to a combination of the domain and terms and the determination whether to display the advertisement is based on the domain and the terms.

22-23. (canceled)

24. The computer readable storage medium according to claim 19, wherein a bid of the bids relates to an advertisement channel and the bid relates to all of the advertisements on a web page that match the domain.

25. (canceled)

26. The computer readable storage medium according to claim 19, wherein a bid of the bids relates to an advertisement channel and the bid relates to all of the advertisements in a list that match the domain.

27. The computer readable storage medium according to claim 19, further comprising selecting a bid on an advertisement channel.

28. The computer readable storage medium according to claim 19, wherein the determination to display the advertisement is based on a bid price and a quality score.
